(19) United States
(12) Patent Application Publication
(10) Pub. No.: US 2017/0279205 A1
(43) Pub. Date: Sep. 28, 2017

(54) DEVICE FOR ELECTRICALLY CONNECTING SYNCHROTRON RING SECTIONS

(71) Applicant: EUROPEAN SYNCHROTRON RADIATION FACILITY, Grenoble (FR)

(72) Inventors: Loys GOIRAND, COUBLEVIE (FR); Thierry BROCHARD, GRENOBLE (FR); Joel PASQUAUD, VILLARD DE LANS (FR)

(21) Appl. No.: 15/463,770

(22) Filed: Mar. 20, 2017

(30) Foreign Application Priority Data
Mar. 22, 2016 (FR) 16/52454

(51) Int. Cl. H01R 4/48; H05H 7/04

(52) U.S. Cl. CPC H01R 4/4809; H05H 7/04

(57) ABSTRACT

A device of electric connection between two successive sections of the ring-shaped pipe of a synchrotron, including: first and second end parts capable of being fastened to the sections, each including a tubular portion with facets; electrically-conductive resilient fingers, each of which bears on each of the two tubular portions while being able to slide on one of said facets; and at least one arm bearing on each finger, each arm being fixed with respect to one of the end parts.

This application claims the priority benefit of French patent application number 16/52454, the content of which is hereby incorporated by reference in its entirety to the maximum extent allowable by law.

### BACKGROUND

The present disclosure relates to a device for electrically connecting sections of the ring-shaped pipe of a synchrotron.

### DISCUSSION OF THE RELATED ART

In an operating synchrotron, a particle beam follows a ring-shaped trajectory. The particle beam travels through a vacuum pipe. The pipe is divided into sections. For example, a synchrotron having more than some hundred meters of circumference is divided into more than one hundred sections of various lengths in the range from 200 mm to 5 m. Each section is included inside of one or a plurality of electromagnets which generate magnetic guide fields. Each section has conductive walls which delimit an inner section which may have a shape variable from one section to another. Neighboring sections are connected by connection devices. Currents enabling the synchrotron to operate travel parallel to the beam in the section walls and in the connection devices. To achieve this, the connection devices have an axial electric continuity which enables the currents to flow parallel to the beam.

During a maintenance or repair phase, the pipe may be filled with outside air. A degassing then has to be carried out. During the degassing, the entire pipe is heated up to temperatures higher than 150° C. and the gases present in the pipe are pumped out. During the heating, thermal expansions cause relative displacements between the ends of neighboring sections. The connection devices should provide an axial electric continuity between sections having a position which may vary. J. T. Seeman et al.'s article entitled “Last Year of PEP-II B-Factory Operation” published in Proceedings of EPAC08, Genoa, Italy, 2008, 946-950, illustrates in FIG. 8 such a connection device.

FIG. 1 is a simplified cross-section view of a connection device 1 similar to the device of FIG. 8 of the above-mentioned article, arranged between sections 3 and 4 of a ring-shaped synchrotron pipe.

Sections 3 and 4 are tubular, with a common axis D. Axis D corresponds to the pipe axis, along which a particle beam is intended to travel. The sections comprise respective flanges 5 and 6 which extend radially from the ends away from axis D. A sealed metal bellows 7 located between the flanges is connected to the periphery of the flanges by sealed fasteners, not shown.

The space delimited by sections 3 and 4, the flanges, and bellows 7 is under vacuum, and connection device 1 is entirely comprised within this space.

Connection device 1 comprises a ring 9, which may be fastened to flange 5 by screws 10 and a ring 11, which may be fastened to flange 6 by screws 12. Ring 11 is axially extended by a tubular portion 13 having the same inner cross-section as section 4.

The device further comprises fingers 15. Each finger 15 has one end held between ring 9 and flange 5 and axially extends in line with the inner surface of section 3. Finger 15 has its other end bearing on the outside of tubular portion 13. For each finger 15, a spring leaf 17 has one end bearing on finger 15 at the location where finger 15 bears on tubular portion 13. The other end of leaf 17 is held in place by one of screws 12.

Sections 3 and 4, tubular portion 13, and fingers 15 are made of electrically-conductive materials. Tubular portion 13 is in electric contact with section 4 on a contact area 19. Each finger 15 is in electric contact with section 3. Electric contacts between tubular portion 13 and fingers 15 result from the bearing of the fingers on this portion under the pressure of spring leaves 17. Currents can then axially flow from section 3 to section 4.

During a relative displacement between sections 3 and 4, fingers 15 fastened to section 3 slide on tubular portion 13 fastened to section 4, tubular portion 13 and fingers 15 remaining in electric contact during the displacement.

Such a device raises various implementation, performance, and reliability issues.

### SUMMARY

Thus, an object of an embodiment is to provide a device of electric connection between two successive sections of a synchrotron pipe, at least partly overcoming some of the above-described disadvantages.

Thus, an embodiment provides a device of electric connection between two successive sections of the ring-shaped pipe of a synchrotron, comprising: first and second end parts capable of being fastened to the sections, each comprising a tubular portion with facets; electrically-conductive resilient fingers, each of which contacts each of the two tubular portions, each contact being a sliding contact with one of said facets; and at least one arm bearing on each finger, each arm being fixed with respect to one of the end parts.

According to an embodiment, said at least one arm comprises first and second arms radially bearing on each finger towards the inside, the first arm being fixed with respect to the first end part and the second arm being fixed with respect to the second end part.

According to an embodiment, the ends of each finger are continued by curved portions.

According to an embodiment: the curved portions are curved on more than a U-turn; and for each finger, each of the arms bearing on the finger is fixed with respect to a third arm comprising a planar surface bearing on the curved portion.

According to an embodiment, the curved portions are curved by an angle in the range from 185 to 220 degrees.

According to an embodiment, the device comprises finger guiding elements.

According to an embodiment, the finger guiding elements are partitions arranged between the facets of the tubular portions.

According to an embodiment, the total clearance between each finger end and the associated guiding partitions is in the range from 0.4 to 0.6 mm.

According to an embodiment, the tubular portion of an end part intended to be fastened to a first section has an inner cross-section on the end side of the device having a shape identical to within 0.5 mm to that of the inner cross-section of the first section.

According to an embodiment, each tubular portion has walls having a thickness smaller than 0.5 mm at the end of the tubular portion located on the finger side.

According to an embodiment, the distance between said at least one arm and the facet closest to said at least one arm is in the range from 1 to 5 mm.

An embodiment provides a synchrotron comprising sections connected by a device such as hereabove.

The foregoing and other features and advantages will be discussed in detail in the following non-limiting description of specific embodiments in connection with the accompanying drawings.

### BRIEF DESCRIPTION OF THE DRAWINGS

FIG. 1 is a simplified cross-section view of a connection device arranged between sections of a ring-shaped synchrotron pipe;

FIG. 2 is a perspective cross-section view of an embodiment of a connection device;

FIG. 3 is a partial simplified cross-section view of another embodiment of a connection device; and

FIG. 4 is a partial simplified cross-section view of another embodiment of a connection device.

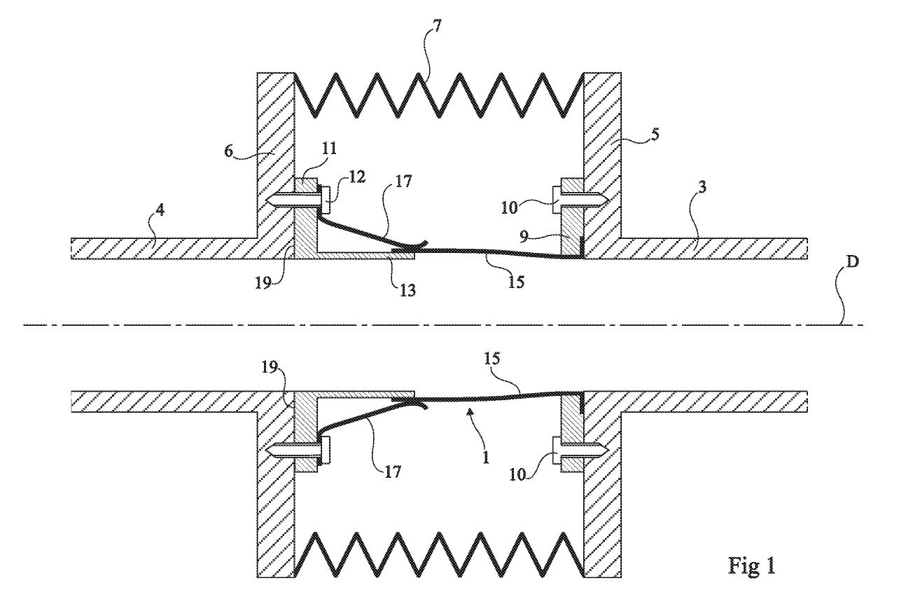

### DETAILED DESCRIPTION

The same elements have been designated with the same reference numerals in the various drawings and, further, the various drawings are not to scale. For clarity, only those steps and elements which are useful for an understanding of the described embodiments have been shown and are detailed.

In the following description, unless otherwise specified, the term “conductive” designates electrically conductive elements.

In the following description, devices of electric connection between two sections of a synchrotron pipe are shown and detailed in a reference position corresponding to aligned sections, that is, in the absence of a relative displacement between sections.

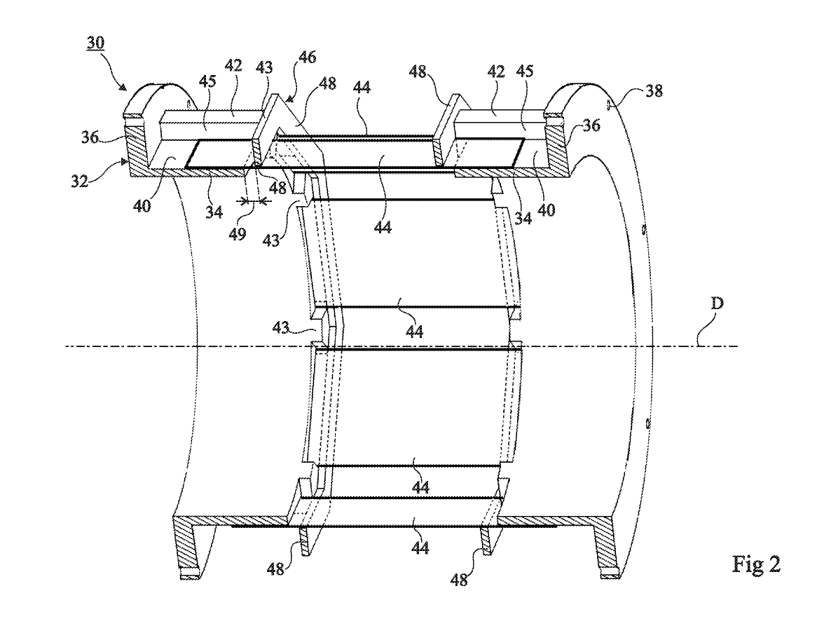

FIG. 2 is a perspective cross-section view of an embodiment of a device 30 for electrically connecting two sections of a ring-shaped synchrotron pipe.

Device 30 comprises two end parts 32 having a common axis D. Axis D corresponds to the axis of a particle beam when device 30 is in place in the operating synchrotron. Each end part 32 comprises a conductive axially-extending tubular portion 34. Tubular portion 34 is for example cylindrical. Other tubular shapes are possible, for example, tubular shapes having a cross-section varying along the axis. Each tubular portion 34 is continued, at its end opposite to the other tubular portion 34, by a ring 36, which extends away from axis D. Each ring 36 is provided with attachment holes 38 and is intended to be fastened to a flange of one of the sections. Each tubular portion 34 and the corresponding section have identical inner cross-sections, for example, having identical shapes to within 0.5 mm.

Each tubular portion 34 comprises facets 40 on its outer surface, each facet being a planar surface parallel to axis D. Neighboring facets are separated by partitions 42 which extend axially. Partitions 42 comprise extensions 43 extending beyond the end of tubular portion 34 on the side opposite to ring 36.

Device 30 comprises resilient conductive fingers 44, each of which extends axially and has ends bearing on two facets 40 located on the two tubular portions 34. In their reference position, the two facets 40 associated with each finger are in a same plane, for example, to within 2 degrees. Thus, each finger bears on each of the two tubular portions 34, and the ends of each finger are located between two partitions 42.

For each end part, a ring-shaped part 46 of axis D and formed of rectilinear portions, that is, of polygonal shape, is fastened to the ends of extensions 43. Each rectilinear portion is parallel to a facet and corresponds, in part 46, to a rigid arm 48 bearing on one of resilient fingers 44.

When device 30 is in place between two sections having their neighboring ends moving closer or drawing away from each other, the fingers axially slide between partitions 42 with respect to one and/or the other of tubular portions 34. Partitions 42 thus enable fingers 44 to be guided during the sliding. A clearance is provided between each finger 44 and the associated partitions 42 to allow relative displacements in a radial, or lateral, direction between the ends of the sections.

Due to arms 48 bearing thereon, fingers 44 remain in electric contact with tubular portions 34 for variable positions of the ends of the sections. Thus, when a particle beam travels in the synchrotron, currents may follow an axial path between sections.

In device 30, the provision of partitions 42 between neighboring fingers 44 enables to guarantee that the fingers remain in place and avoids any risk for neighboring fingers to overlap. Device 30 is thus particularly reliable.

As an example, fingers 44 are made of a copper alloy containing beryllium, for example, between 1% and 3% of beryllium. The fingers may have thicknesses in the range from 0.15 to 0.25 mm. The distance separating each arm 48 from the facet 40 closest to the arm may be in the range from 1 to 5 mm. As an example, the end parts may be made of stainless steel or of an aluminum alloy, for example, of a 7075 aluminum alloy. As an example, the sum of the clearances between a finger end 44 and each of the two associated partitions 42, or total clearance between the finger end and the partitions, is in the range from 0.4 to 0.6 mm.

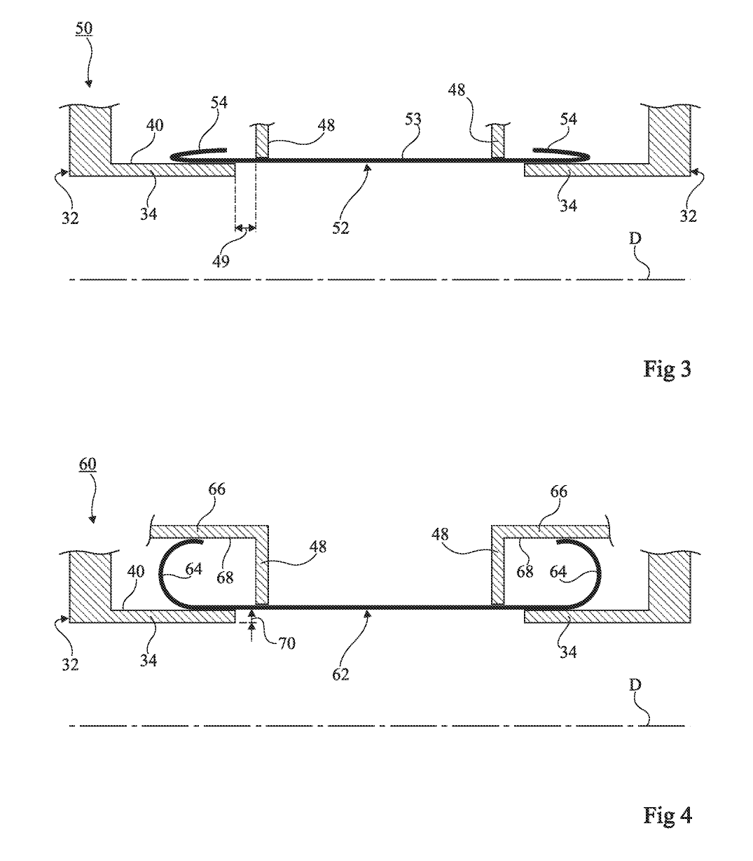

FIG. 3 is a partial simplified cross-section view of another embodiment of a device 50 for electrically connecting two sections of a ring-shaped pipe of a synchrotron. Device 50 corresponds to device 30 of FIG. 2 where fingers 44 have been replaced by fingers 52. It thus comprises end parts 32 each comprising a tubular portion 34 and a ring 36 (partially shown). It also comprises arms 48, each of which is fixed with respect to one of parts 32 via partitions 42, which are not shown in FIG. 3.

A central portion 53 of fingers 52 is arranged in the same way as fingers 44 of FIG. 2. In this embodiment, the ends of fingers 52 comprise curved portions 54.

As an example, each curved portion extends central portion 53 along a direction which varies from an axial direction to an end direction. An angle between the end direction and the axial direction characterizes each curved portion. The curved portion may for example have, in cross-section along axis D, the shape of an arc of a circle. The angle which characterizes the curved portion, or the angle of the curved portion, then corresponds to the angle of the arc of a circle. In the shown example, the curved portions are half-turn shaped, that is, they have angles of 180° to within 5°. Curved portions 54 are curved outwards, that is, the curved portions of each finger 52 start from the central portion away from axis D.

When device 50 is not in place, it may occur, for example during handling operations, for end parts 32 to draw away from each other. Such a drawing away is stopped when the curved portions 54 of fingers 52 abut against arms 48. Device 50 can then be handled without risking for the elements of the device to separate.

FIG. 4 is a partial simplified cross-section view of another embodiment of a device 60 for electrically connecting two sections of a ring-shaped pipe of a synchrotron. Device 60 corresponds to device 30 of FIG. 2 in which fingers 44 have been replaced by fingers 62 having their ends comprising curved portions 64, which are curved by more than a half-turn, that is, curved portions 64 have angles greater than 180 degrees. As an example, curved portions 64 located at each end are curved by angles in the range from 185 to 220 degrees. Curved portions 64 are curved outwards. Thereby, at the end of each tubular portion 34 located on the finger side, the inner surface of the tubular portion is only separated from the fingers by thickness 70 of the wall of the tubular portion.

An arm 66 extends axially from each arm 48 towards end part 32 fixed with respect to arm 48. Each arm 66 has on the side of axis D a surface 68 parallel to a facet 40 and located opposite the facet. Each curved portion 64 bears on one side on a surface 68 and on the other side on a facet 40.

When device 60 is in place between sections having their ends coming closer to or drawing away from each other, the fingers slide at the same time on facets 40 and on surfaces 68.

The provision, in device 60, of arms 48 bearing on fingers 62 and of arms 66 bearing on the curved portions enables to maintain a particularly conductive electric contact between each finger 62 and the associated facet 40. When a particle beam travels through the synchrotron, the resistance which opposes the axial flow of currents is thus particularly low.

As an example, curved portions 64 of a finger 62 have a radial dimension, or height, in the range from 4 to 7 mm. The height which separates a facet 40 from the opposite surface 68 may be the height that a curved portion 64 would have in the absence of an arm 66, minus a compression height smaller than 1 mm.

An advantage of the previously-described embodiments is that the provision of the rigid arms fixed with respect to the end parts and bearing on the fingers, each finger bearing on facets of the two tubular portions while being able to slide thereon, provides a particularly reliable electric contact.

Specific embodiments have been described. Various alterations and modifications will occur to those skilled in the art. In particular, although, in the described embodiments, the inside of each tubular portion is cylindrical with an axis D, internal cross-sections which progressively vary along axis D may be provided in other embodiments. Thus, a device of electric connection between sections having inner cross-sections of different shapes may be obtained. Each tubular portion then has, at the end level of the device, an inner cross-section identical to that of the corresponding section. Tubular portions having an inner cross-section close to the outer cross-section of the tubular portion may also be provided at the level of the end located on the finger side, so that the tubular portion has, at this end, a wall of small thickness (bearing reference 70 in FIG. 4), for example, smaller than 0.5 mm.

Further, although, in the described embodiments, the fingers extend axially, other embodiments of devices of electric connection between sections having inner cross-sections of different shape may be provided, where the fingers may also extend along a direction forming a small angle with axis D, for example, an angle smaller than 5 degrees.

Further, although arms 48 are arms of a ring-shaped part 46 fixed with respect to an end part 32, the arms may be fastened to end part 32 in any other way compatible with the sliding of the resilient fingers on the facets. For example, in variations of the embodiments described in relation with FIGS. 3 and 4, arms 66, which extend the arms, may be fastened to a surface of partitions 42 located on the side opposite to axis D, and extensions 43 of the partitions can then be omitted.

Although, in the embodiments described in relation with FIG. 4, arms 48 and arms 68 bear against the resilient fingers, other embodiments are possible where only arms 66 bear against the resilient fingers.

Although, in the described embodiments, the fingers are arranged between guiding partitions 42, the fingers may also be guided by any guiding element capable of ensuring that the fingers remain in place and of avoiding any risk for neighboring fingers to overlap.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A device of electric connection between two successive sections of the ring-shaped pipe of a synchrotron, comprising:
first and second end parts capable of being fastened to the sections, each comprising a tubular portion with facets;
electrically-conductive resilient fingers, each of which contacts each of the two tubular portions, each contact being a sliding contact with one of said facets; and
at least one arm bearing on each finger, each arm being fixed with respect to one of the end parts.

2. The device of claim 1, wherein said at least one arm comprises first and second arms bearing radially on each finger towards the inside, the first arm being fixed with respect to the first end part and the second arm being fixed with respect to the second end part.

3. The device of claim 2, wherein the ends of each finger are extended by curved portions.

4. The device of claim 3, wherein:
the curved portions are curved by more than a half-turn; and
for each finger, each of the arms bearing on the finger is fixed with respect to a third arm comprising a planar surface bearing on the curved portion.

5. The device of claim 4, wherein the curved portions are curved by an angle in the range from 185 to 220 degrees.

6. The device of claim 1, comprising finger guiding elements.

7. The device of claim 6, wherein the finger guiding elements are partitions arranged between the facets of the tubular portions.

8. The device of claim 7, wherein the total clearance between each finger end and the associated guiding partitions is in the range from 0.4 to 0.6 mm.

9. The device of claim 1, wherein the tubular portion of an end part intended to be fastened to a first section has an inner cross-section on the end side of the device having a shape identical to within 0.5 mm to that of the inner cross-section of the first section.

10. The device of claim 1, wherein each tubular portion has walls having a thickness smaller than 0.5 mm at the end of the tubular portion located on the finger side.

11. The device of claim 1, wherein the distance between said at least one arm and the facet closest to said at least one arm is in the range from 1 to 5 mm.

12. A synchrotron comprising sections connected by the device of claim 1.
